(19) United States
(12) Patent Application Publication
(10) Pub. No.: US 2006/0263286 A1
(43) Pub. Date: Nov. 23, 2006

(54) Preparation of olivine Li Fe PO4 cathode materials for lithium batteries via a solution method

(75) Inventors: She-Huang Wu, Taipei City (TW); Wen-Jen Liu, Kaohsiung City (TW); Kai-Mo Hsiao, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/265,095

(22) Filed: Nov. 3, 2005

(30) Foreign Application Priority Data
Nov. 3, 2004 (TW) 093133523

(51) Int. Cl. C01B 25/45

(52) U.S. Cl. 423/306

(57) ABSTRACT

A preparation method of olivine Li₁₊ₓFe_{1+y}PO₄ is disclosed, wherein −0.2≦x≦0.2 and −0.2≦y≦0.2, which includes the following steps: (A) adding iron powder, lithium salt, and phosphate into an acid solution to form a mixture, wherein the molar ratio of Li⁺:Fe²⁺:PO₄³⁻ is 1+x:1+y:y; (B) stirring the mixture; (C) drying the mixture to obtain solid precursor powder; and (D) heating the precursor solid powder at a temperature over 500° C. to form olivine structured powders.

### BACKGROUND OF THE INVENTION

1. Field of the Invention

The present invention relates to a method of preparing cathode material and, more particularly to a method of preparing LiFePO₄ cathode materials.

2. Description of Related Art

Currently, due to the rising development of portable, wireless, or lightweight electronic products, such as mobile phones, notebooks, digital cameras, and many other portable devices, there has been an expanding need for secondary batteries being the power sources for these applications. Among the commercialized secondary batteries, lithium ion batteries exhibit advantages of high energy density, environmental benignity, and excellent cycling performance. These characteristics make the lithium ion batteries meet the requirement of lightweight and small volume for being the power sources of portable electronic devices, and are already applied in various portable 3C products.

Cathode material is a key component of a lithium secondary battery, wherein the olivine structured LiFePO₄ is getting more attention because of its high theoretical capacity, high thermal stability, low pollution to environment, and ease to obtain. Although olivine exists in natural minerals, the purity of LiFePO₄ is low. Therefore, olivine structured LiFePO₄ for cathode material is generally prepared artificially. In the known preparation methods, ferric compounds, such as ferric sulphate (Fe₂(SO₄)₃.9H₂O), ferric nitrate (Fe(NO₃)₃.9H₂O), and ferric acetate (Fe(CH₃COO)₃) are used as starting materials. Though these compounds are relatively easy to obtain, the cost is high for mass production. The known methods of preparing olivine structured LiFePO₄ are usually processing with a solid state reaction. In other words, the starting materials of lithium salts, iron salts and salts of phosphate are grinded and mixed with stoichiometric ratio before heat treatment. The mixed powders are heated subsequently. Moreover, the solid-state reactions proceed at high temperatures for a long period are required. The diameter of the particles of the prepared powder becomes large (50 μm in diameter) and the large particles further lower the electrical conductivity of the prepared cathode. In addition, the contamination introduced during grinding and mixing also induce the difficulty in controlling the composition of prepared powders. Therefore, it is desirable to provide a method of preparing LiFePO₄-based cathode materials to mitigate and/or obviate the aforementioned problems.

### SUMMARY OF THE INVENTION

The present invention relates to a method for preparing Li₁₊ₓFe_{1+y}PO₄ with the oxidation of iron into Fe²⁺, wherein −0.2≦x≦0.2 and −0.2≦y≦0.2. The method comprises the following steps: (A) adding iron powder, lithium salt, and phosphate into an acid solution to form a mixture, wherein the molar ratio of Li⁺:Fe²⁺:PO₄³⁻ is 1+x:1+y:y; (B) stirring the mixture solution; (C) drying the solution to obtain a solid precursor powder; and (D) heating the precursor solid powder at a temperature over 500° C. Compared with the conventional method, the cost of the present invention is lower due to the price of iron powder is lower than that of any pure compound of iron, whereby there is significant benefit for the relevant industries.

In the present invention, iron powder is oxidized into Fe²⁺ by acid solution; oxidations of iron into Fe²⁺ with any acidic solution are in the scope of the invention.

The drying procedure for drying the mixture in step (C) of the present invention can be any conventional way. Preferably, the mixture is dried by direct heating or spray-drying in step (C). The atmosphere for heat treatment in step (D) of the present invention can be atmosphere of any inert gas. Preferably, the the precursor solid powder is heated in an atmosphere of nitrogen or argon in step (D). The lithium salt used in the present invention can be any conventional lithium salt. Preferably, the lithium salt is lithium nitrate, lithium acetate, lithium chloride, lithium hydroxide, lithium hydrogen phosphate or lithium phosphate. The phosphate used in the present invention can be any conventional phosphate. Preferably, the phosphate is ammonium phosphate, ammonium hydrogen phosphate, ammonium dihydrogen phosphate, lithium phosphate, lithium hydrogen phosphate, lithium ammonium phosphate or phosphoric acid. The acid solution used in the present invention can be any conventional acid solution. Preferably, the acid solution is acetic acid, citric acid, oxalic acid, tartaric acid, propionic acid, butyric acid or a mixture thereof. The time for heat treatment in step (D) of the present invention is over 6 hours preferably.

In addition, at least a carbohydrate can also be added with the iron powder, the lithium salt, and the phosphate into the acid solution to form the mixture in step (A) of the present invention so as to produce nano-carbon particles through heat treatment to increase conductivity of the product. The carbohydrate used in the present invention can be any conventional carbohydrate. Preferable, carbohydrate is sucrose. The amount of the carbohydrate to the Li₁₊ₓFe_{1+y}PO₄ used in the present invention is small. Preferably, the weight percentage of the carbohydrate to the Li₁₊ₓFe_{1+y}PO₄ is 5% to 25%.

The method of the present invention is achieved by oxidizing iron powder into 2-valance Fe (Fe²⁺) by acid solution. Therefore, any method that is achieved by oxidizing iron or ferric oxide powder into stable or sub-stable Fe²⁺ by acid solution for preparing Li₁₊ₓFe_{1+y}PO₄ material is conformed to the method of the present invention.

### BRIEF DESCRIPTION OF THE DRAWINGS

FIG. 1 shows the X-ray diffraction pattern of the cathode material prepared according to Example 1 of the present invention;

FIG. 2 shows the cycle life characteristic of the cell prepared according to Example 1 of the present invention;

FIG. 3 shows the X-ray diffraction pattern of the cathode material prepared according to Example 2 of the present invention; and

FIG. 4 shows the cycle life characteristic of the cell prepared according to Example 2 of the present invention.

### DETAILED DESCRIPTION OF THE PREFERRED EMBODIMENT

The molar ratio of iron powder, lithium salt, and phosphate used in the present invention can be any conventional molar ratio. In the present example, the molar ratio of iron powder, lithium salt, and phosphate is 1:1:1. Therefore, the molar ratio of Li⁺, Fe²⁺ and PO₄³⁻ is 1:1:1.

### EXAMPLE 1

A mixture is made by adding 0.1 mole iron powder, 0.1 mole LiNO₃, and 0.1 mole (NH₄)₂HPO₄ into 200 ml of solution containing 0.1 mole citric acid. The molar ratio of Li⁺, Fe²⁺ and PO₄³⁻ in the mixture solution is 1:1:1. 1.8 g of sucrose is added into the mixture after iron react completely. Then, the temperature of the mixture is raised to dry the mixture (direct drying) to obtain LiFePO₄ precursor powder. The LiFePO₄ precursor powder is then placed in an oven and heated at 700° C. for 12 hours under flowing nitrogen, after which 18 g of olivine LiFePO₄ cathode powder material is obtained.

Testing Result:

a. X-Ray Diffraction Analysis:

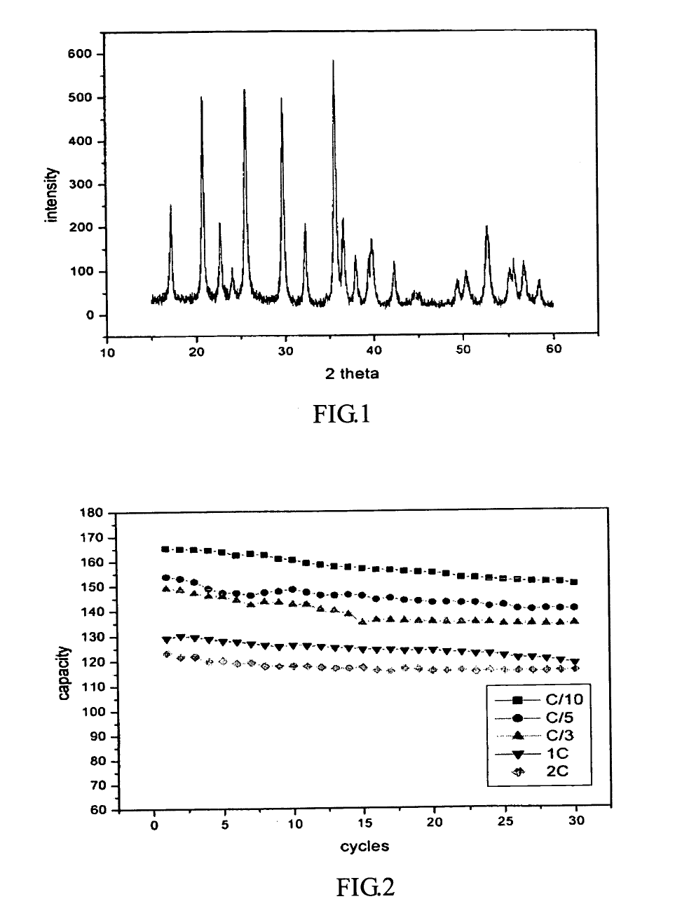

First, in reference to FIG. 1, a typical X-ray diffraction pattern of olivine is shown, which means that the present example of the method for preparing olivine LiFePO₄ can exactly produce pure olivine powder with high purity.

For the known method for preparing pure olivine LiFePO₄, 3-valence iron, for example Fe₂(SO₄)₃.9H₂O or Fe(NO₃)₃.9H₂O are used as the starting material. Synthesis reaction is performed by reducing 3-valence iron (Fe³⁺) to 2-valence iron (Fe²⁺). The present invention of the preparing method includes using iron powder as starting material which can be gained easily with low cost. Compared with the conventional method, the present invention tends to oxidize the iron powder to a 2-valence iron (Fe²⁺), so it is different from the prior art. In addition, the iron powder is very cheap, such that there are significant benefits in lowering the production cost. High purity olivine powder can be obtained through the method of the present invention. The obtained powder shows apparent improvement in the preparation of olivine LiFePO₄-based cathode materials.

Then the obtained olivine powder is used as the cathode material of a lithium ion battery to study the cycling performance of the prepared powder.

b. Cycle Life Test:

The powder obtained from the present embodiment, acetylene carbon black, and polyvinylidene fluoride (PVDF) are mixed thoroughly in N-methylpyrrolidone (NMP) solvent according to a weight ratio of 83:10:7 to become slurry. The slurry is then tape-cast on an Al foil and dried, followed by punching into disks and used as positive electrodes. The positive electrode combines with the lithium metal to construct a coin-type cell for cycle life test.

The cycle life test is performed for 30 cycles by charging-discharging the cell within the cut-off voltages of 3.0 and 4.3 V with various rates (C/10 to 2C rate). The results of cycling performance are shown in FIG. 2. The initial capacity of the cell comprised with the cathode material prepared in the present embodiment is 165 mAh/g as it was cycled with C/10 rate (0.06 mA/cm2) at room temperature. However, it still exhibits a specific capacity of 150 mAh/g after 30 cycles. The result indicates that the cathode material prepared in the present embodiment has an excellent charging-discharging characteristic and the capacity of the cell comprised with the cathode material of the present embodiment does not deteriorate much as it was cycled with C/10 rate. For cells cycled with 2C rate, an initial specific capacity of 123 mAh/g rate (1 mA/cm²) was obtained and specific capacity of 115 mAh/g was determined after 30 cycles. The result indicates that the cathode materials prepared by the method of the present embodiment still have an excellent charging-discharging characteristic and capacities with high charging-discharging rates.

### EXAMPLE 2

A mixture is prepared by adding 0.1 mole iron powder, 0.1 mole LiNO₃, and 0.1 mole (NH₄)₂HPO₄ into 200 ml of solution which containing 0.1 mole of citric acid. After thoroughly mixed, 1.8 g of sucrose was added into the mixture with Li⁺, Fe²⁺ and PO₄³⁻ molar ratio of 1:1:1. Then, the mixture was spray-dried to result in LiFePO₄ precursor powder. The LiFePO₄ precursor powder is placed in nitrogen flowing oven and heated at 700° C. for 12 hours and 18 g olivine LiFePO₄ cathode powder material is obtained finally.

Testing Result:

a. X-Ray Diffraction Analysis:

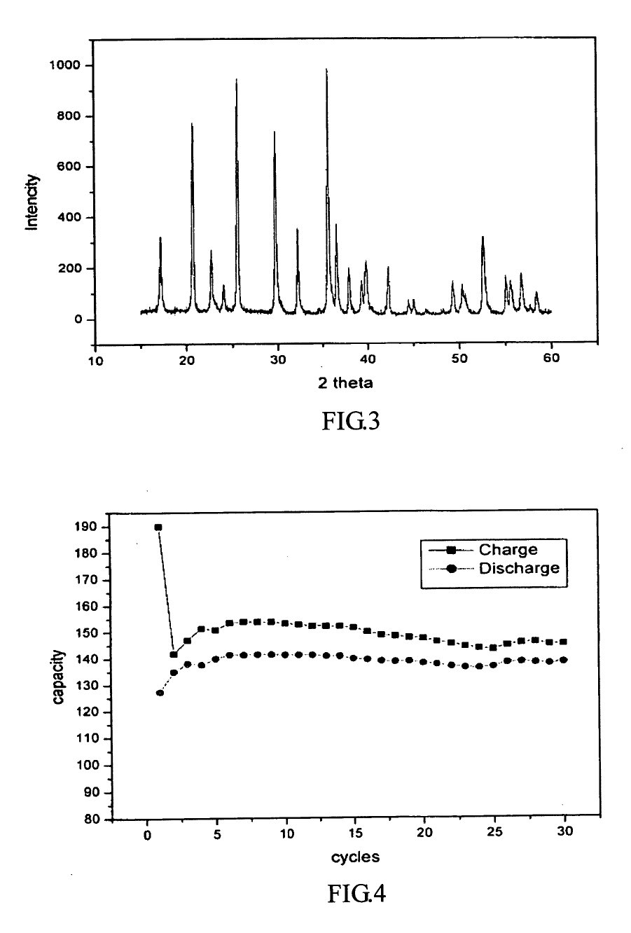

As the X-ray diffraction pattern shown in FIG. 3, olivine LiFePO₄ without any secondary phase can be prepared by the present invention with spray-drying. Therefore, the method of the present invention can be achieved by any conventional drying or spray drying methods followed by heat treatment at adequate temperatures to obtain LiFePO₄ of olivine crystal phase.

The LiFePO₄ powder of the present embodiment is then investigated by a scanning electron microscope (SEM). It was found that the average particle size of the synthesized LiFePO₄ powder is around 2 μm in diameter.

b. Cycle Life Test:

The method of preparing coin-type cells for cycle life test is the same as that used in example 1. The cycle life test is performed by charging-discharging the cell within the cut-off voltages of 2.5 and 4.5 V with 1 C rate (0.51 mA/cm²) at room temperature. The results of cycle life test are shown in FIG. 4. The initial capacity of the cell comprised with the cathode material of the present embodiment is 125 mAh/g and tends to stabilize and remains at about 138 mAh/g after 3 cycles. No substantial deterioration is found after 30 cycles.

The method proposed by the present invention is obviously superior to the conventional method. The material of synthesis olivine LiFePO₄ in the present invention is iron powder, which is much cheaper than the price of any iron salts used in the conventional method. Hence, there are significant benefits in lowering the cost of mass production. Besides, the method of the present invention tends to oxidize the iron powder to a 2-valence iron, and is different from the reduction used in the conventional method. Furthermore, the prepared LiFePO₄ powders of the present invention have smaller particle size than that of particles prepared by convention method. Therefore, diffusion distance of Li⁺ is shortened and the ionic conductivity of the cathode material can be rised. Compared with the conventional method, the steps of the method of the present invention is easy. Moreover, the processing time of the method of the present invention is short, and the temperature of heat treatment is low. Furthermore, no grinding process is required in the method for preparation LiFePO₄ of the present invention. Hence, contamination introduced by grinding can be prevented, and the composition of the prepared cathode material therefore can be controlled easily.

The cathode materials prepared in the present invention do not only lower the production cost but also exhibit excellent charging-discharging characteristic. Therefore, the cathode materials prepared in the present invention can improve the cost, and the time-consuming problem for mass-production.

Although the present invention has been explained in relation to its preferred embodiment, it is to be understood that many other possible modifications and variations can be made without departing from the spirit and scope of the invention as hereinafter claimed.

What is claimed is:

1. A method for preparing Li₁₊ₓFe_{1+y}PO₄, wherein −0.2≦x≦0.2 and −0.2≦y≦0.2, with the oxidation of iron into Fe²⁺ and comprising the following steps:
(A) adding iron powder, lithium salt, and phosphate into an acid solution to form a mixture, wherein the molar ratio of Li⁺:Fe²⁺:PO₄³⁻ is 1+x:1+y:y;
(B) stirring the mixture;
(C) drying the mixture to obtain solid precursor powder; and
(D) heating the precursor solid powder at a temperature over 500° C.

2. The method for preparing Li₁₊ₓFe_{1+y}PO₄ of claim 1, wherein the mixture is dried by direct heating in tep (C).

3. The method for preparing Li₁₊ₓFe_{1+y}PO₄ of claim 1, wherein the mixture is dried by spray-drying in step (C).

4. The method for preparing Li₁₊ₓFe_{1+y}PO₄ of claim 1, wherein the precursor solid powder is heated in an atmosphere of nitrogen or argon in step (D).

5. The method for preparing Li₁₊ₓFe_{1+y}PO₄ of claim 1, wherein said lithium salt is lithium nitrate, lithium acetate, lithium chloride, lithium hydroxide, lithium hydrogen phosphate or lithium phosphate.

6. The method for preparing Li₁₊ₓFe_{1+y}PO₄ of claim 1, wherein said phosphate is ammonium phosphate, ammonium hydrogen phosphate, ammonium dihydrogen phosphate, lithium phosphate, lithium hydrogen phosphate, lithium ammonium phosphate or phosphoric acid.

7. The method for preparing Li₁₊ₓFe_{1+y}PO₄ of claim 1, wherein said acid solution is acetic acid, citric acid, oxalic acid, tartaric acid, propionic acid, butyric acid or a mixture thereof.

8. The method for preparing Li₁₊ₓFe_{1+y}PO₄ of claim 1, wherein at least a carbohydrate is added with the iron powder, the lithium salt, and the phosphate into the acid solution to form the mixture in step (A), and the weight percentage of the carbohydrate to the Li₁₊ₓFe_{1+y}PO₄ is 5% to 25%.

9. The method for preparing Li₁₊ₓFe_{1+y}PO₄ of claim 1, wherein the precursor solid powder is heated over 6 hours in step (D).
